(19) United States
(12) Patent Application Publication
(10) Pub. No.: US 2021/0162305 A1
(43) Pub. Date: Jun. 3, 2021

(54) GAME DEVICE, GAME PROCESSING METHOD, AND MEDIUM

(71) Applicant: SQUARE ENIX CO., LTD., Tokyo (JP)

(72) Inventors: Kazuki ITO, Tokyo (JP); Isao OHTA, Tokyo (JP); Kiminori ONO, Tokyo (JP); Michio TAKAHASHI, Tokyo (JP)

(73) Assignee: SQUARE ENIX CO., LTD., Tokyo (JP)

(21) Appl. No.: 17/111,282

(22) Filed: Dec. 3, 2020

(30) Foreign Application Priority Data
Dec. 3, 2019 (JP) 2019-219044

(51) Int. Cl. A63F 13/577; A63F 13/65; G06T 11/00; G06T 7/70

(52) U.S. Cl. CPC A63F 13/577; A63F 13/65; A63F 13/213; G06T 7/70; G06T 11/00

(57) ABSTRACT

A game device is provided with an object detection unit for detecting positions of a plurality of real objects from a predetermined area, an object control unit for disposing a game object in a virtual area, a collision detection unit for detecting, in the virtual area, collisions between each of a plurality of player objects, which are disposed in positions corresponding to the detected positions of the plurality of real objects, and the game object, a parameter updating unit for updating a parameter of the game each time a collision is detected, a rendering unit for generating a game screen by rendering the virtual area, and a display unit for displaying the game screen in a position that can be seen from the predetermined area.

### CROSS-REFERENCE TO RELATED APPLICATIONS

This application claims priority to and the benefit of Japanese Patent Application No. 2019-219044, filed on Dec. 3, 2019, the disclosure of which is expressly incorporated herein by reference in its entirety.

### FIELD OF THE INVENTION

The present disclosure relates to an augmented reality (AR) technique.

### BACKGROUND

In a technique proposed in the related art, content is displayed in a display area, and the display matters of the content are controlled in accordance with whether or not a user exists within a predetermined range in front of the display area. See WO 2018/034046.

A technique of advancing flow of a game by detecting that a user has performed a predetermined operation to a display position of an image has also been proposed. See HUIS TEN BOSCH Co., Ltd., “Bahamut Disco/event & news/Huis Ten Bosch resort”, [online], [retrieved Nov. 25, 2019], Internet <URL: https://www.huistenbosch.co.jp/event/vr/bahamut-disco/>.

### SUMMARY

Various augmented reality techniques for adding information to a real space by displaying a virtual object so as to be superimposed on the real space or an image of the real space have been proposed in the related art, and these techniques include a technique that allows the user to interfere with an object existing in a displayed virtual space by means of gestures or the like.

In most of these conventional techniques, however, the user and the object in the virtual space simply interact on a one-to-one basis, and therefore these techniques do not allow a many-to-one game, in which a plurality of users gathered in a single location interact cooperatively with a single object in a virtual space, to be played without using a special controller or the like.

An object of at least one embodiment of the present disclosure is to solve the problem described above by enabling a many-to-on game, in which a plurality of users gathered in a single location interact cooperatively with a single object in a virtual space, to be played without using a special controller or the like.

According to a non-limiting aspect, one aspect of the present disclosure is a game device including object detection for detecting positions of a plurality of real objects from a predetermined area, in which a plurality of players are present, on the basis of information input from a sensor for sensing the predetermined area, object controlling for disposing a game object in a virtual area used for a game played by the plurality of players, collision detection for detecting, in the virtual area, collisions between each of a plurality of player objects, which are disposed in positions corresponding to the detected positions of the plurality of real objects, and the game object, updating a parameter of the game each time the collision detection detects a collision between each of the plurality of player objects and the game object, rendering for generating a game screen that includes images of the plurality of player objects and an image of the game object by rendering the virtual area, and displaying the game screen in a position that can be seen by the plurality of players from the predetermined area.

Note that the present disclosure can also be interpreted as an information processing device, an information processing system, a method executed by a computer, or a program that a computer is caused to execute.

Moreover, the present disclosure can also be interpreted as being realized by recording such a program on a recording medium that is readable by a computer or another device, machine, or the like. Here, a recording medium that is readable by a computer or the like is a recording medium in which information such as data and programs can be stored by an electrical, magnetic, optical, mechanical, or chemical action and read from a computer or the like.

One or more deficiencies are solved by the embodiments of the present application.

### BRIEF DESCRIPTION OF THE DRAWINGS

FIG. 1 is a schematic view showing a functional configuration of a game device corresponding to at least one embodiment of the present disclosure;

FIG. 2 is a flowchart showing a flow of virtual area control processing corresponding to at least one embodiment of the present disclosure;

FIG. 3 is a schematic view showing a configuration of a game device corresponding to at least one embodiment of the present disclosure;

FIG. 4 is a schematic view showing a configuration of an information processing device corresponding to at least one embodiment of the present disclosure;

FIG. 5 is a view showing an example of a game screen corresponding to at least one embodiment of the present disclosure; and

FIG. 6 is a flowchart showing a flow of virtual area control processing corresponding to at least one embodiment of the present disclosure.

### DESCRIPTION OF EMBODIMENTS

Embodiments of the present disclosure will be described below on the basis of the figures. Note that the embodiments described below merely illustrate examples of cases of implementation of the present disclosure, and the present disclosure is not limited to the specific configurations described below. When implementing the present disclosure, specific configurations corresponding to the embodiments may be employed as appropriate.

### First Embodiment

### Device Configuration

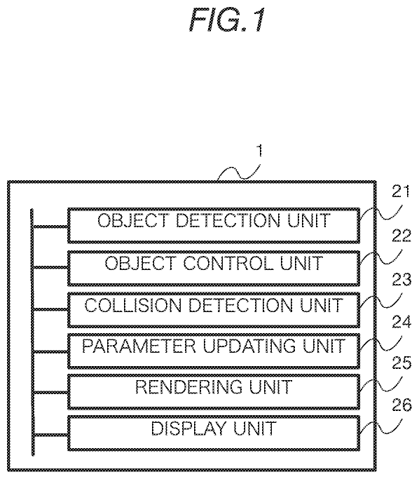

FIG. 1 is a schematic view showing a functional configuration of a game device 1 according to this embodiment. The game device 1 according to this embodiment includes a sensor for sensing a predetermined area in which a plurality of players are present, a display device installed in a position that can be seen by the plurality of players in the predetermined area, and a computer connected to the sensor and the display device. By having a processor of the computer interpret and execute various programs expanded in various memories, the game device 1 functions as a game device having an object detection unit 21, an object control unit 22, a collision detection unit 23, a parameter updating unit 24, a rendering unit 25, and a display unit 26. In this embodiment, an example in which the functions of these units are all executed by a general-purpose processor will be described. However, some or all of the functions may be realized by one or a plurality of dedicated processors. Moreover, the respective function units of the game device 1 may be packaged in a cloud, a server, or the like, for example. Furthermore, the function units may be realized by a plurality of software modules rather than a single software module.

The object detection unit 21 detects positions of a plurality of real objects from the predetermined area in which the plurality of players are present.

The object control unit 22 disposes a game object in a virtual area used for a game played by the plurality of players.

The collision detection unit 23 detects collisions between each of a plurality of player objects, which are disposed in the virtual area in positions corresponding respectively to the detected positions of the plurality of real objects, and the game object.

The parameter updating unit 24 updates a game parameter each time the collision detection unit 23 detects a collision between one of the plurality of player objects and the game object.

The rendering unit 25 generates a game screen including images of the plurality of player objects and an image of the game object by rendering the virtual area.

The display unit 26 displays the game screen in a position that can be seen by the plurality of players from the predetermined area.

Processing Flow

Next, a flow of processing executed in this embodiment will be described, Note that the specific content and processing sequences of the processing illustrated on the flowcharts according to the embodiments are merely examples of implementations of the present disclosure, and the specific processing content and processing sequence may be selected as appropriate in accordance with the embodiment of the present disclosure,

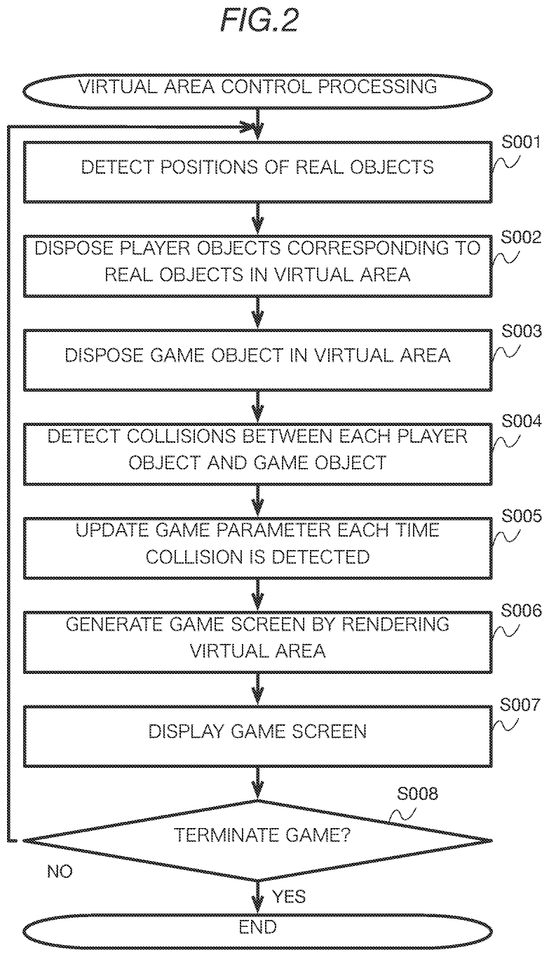

FIG. 2 is a flowchart showing a flow of virtual area control processing according to the first embodiment. The processing illustrated on this flowchart is started in the game device 1 when the processing of a game program is started, and is executed repeatedly thereafter.

In step S001, positions of real objects are detected. Here, the real objects are objects having substance and existing in a real space. The object detection unit 21 detects the positions of a plurality of real objects from a predetermined area on the basis of information input from the sensor. The processing then advances to step S002.

In step S002, player objects are disposed in a virtual area of a game. Here, the player objects are objects that appear in a virtual area used tier a game played by a plurality of players on the game device 1 according to this embodiment, and that are moved by the players. The object control unit 22 disposes a plurality of player objects in positions within the virtual area that correspond respectively to the detected positions of the plurality of real objects detected in step S001. In other words, in a game according to this embodiment, the players manipulate the positions of the player objects in the virtual area by moving the positions of the objects detected as the real objects. The processing then advances to step S003.

In step S003, a game object is disposed in the virtual area of the game. Here, the game object is a virtual object such as a character or an item that appears in the virtual area used for the game according to this embodiment, and includes an attack target of the game. The object control unit 22 disposes the game object in the virtual area, whereupon the processing advances to step S004.

In step S004, collisions between the player objects and the game object are detected. The collision detection unit 23 detects collisions between the plurality of player objects and the game object disposed respectively in step S002 and step S003. In other words, the game device 1 according to this embodiment detects collisions between the player objects and the game object with respect to each player object. The processing then advances to step S005.

In step S005, the game parameter is updated in response to a detected collision. The parameter updating unit 24 updates the game parameter each time the collision detection unit 23 detects a collision between one of the player objects and the game object. The processing then advances to step S006.

In step S006 and step S007, a game screen is generated and output. The rendering unit 25 generates a game screen including images of the plurality of player objects and an image of the game object by rendering the virtual area on which the plurality of player objects and the game object were disposed in step S003 (step S006). The display unit 26 then displays the game screen on the display device (step S007). As noted above, the display device is installed in a position that can be seen by the plurality of players from the predetermined area, and therefore the players can manipulate the positions of the player objects within the virtual area by moving the positions of the objects detected as the real objects while viewing the game screen displayed on the display device, thereby advancing the game. The processing then returns to step S001, whereupon the processing illustrated on the flowchart is executed repeatedly until a predetermined termination condition is satisfied (YES in step S008).

With the game device 1 according to this embodiment, it is possible to provide a technique that allows a many-to-one game, in which a plurality of users gathered in a single location interact cooperatively with a single object in a virtual space, to be played without using a special controller or the like.

### Second Embodiment

Next, a second embodiment will lie described. Identical configurations and processing content to the first embodiment can be ascertained by referring to the first embodiment, and therefore description thereof has been omitted.

Device Configuration

The game device 1 according to this embodiment, similarly to the game device 1 described in the first embodiment with reference to FIG. 1, includes the object detection unit 21, the object control unit 22, the collision detection unit 23, the parameter updating unit 24, the rendering unit 25, and the display unit 26. Lin this embodiment, however, a part of the processing content differs from the processing content described in the first embodiment. Further, in this embodiment, an imaging device that acquires a moving image by image-capturing the predetermined area is used as the sensor.

In the second embodiment, the object detection unit 21 detects moving objects ley analyzing a moving image acquired from the imaging device and detecting movement within the moving image. The object detection unit 21 then detects the positions of the moving objects as positions of real objects.

Further, in the second embodiment, the collision detection unit 23 detects collisions between player objects corresponding to the moving objects and the game object.

Furthermore, in the second embodiment, the parameter updating unit 24 updates a parameter associated with the game object.

Moreover, in the second embodiment, the rendering unit 25 uses at least a part of the moving image as the images of the plurality of player objects. For example, the rendering unit 25 can generate a game screen including images of the plurality of player objects and an image of the game object by synthesizing the image of the game object with the moving image acquired by the imaging device.

Processing Flow

The flow of virtual area control processing according to the second embodiment is substantially identical to the processing flow described in the first embodiment with reference to FIG. 2 except that the details of the processing executed in the respective steps differ in terms of the points described above, Therefore, description of the processing flow has been omitted.

### Third Embodiment

### Device Configuration

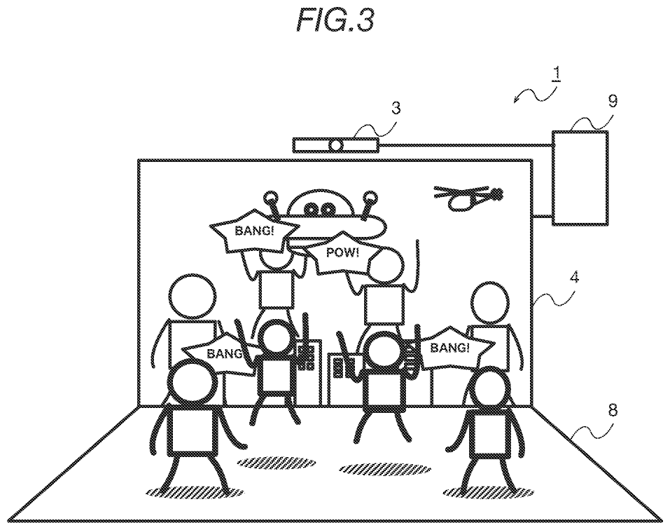

FIG. 3 is a schematic view showing a configuration of the game device 1 according to this embodiment. The game device 1 of this embodiment includes a display (a display device) 4 installed on one side (the long edge side in this embodiment) of a rectangular play area (a predetermined area) 8 that is large enough to allow a plurality of players to play a game while moving around, a camera sensor (an imaging device) 3 installed above the center of a display area of the display 4 in order to image-capture the play area 8, and an information processing device (a computer) 9 to which the display 4 and the camera sensor 3 are connected.

Note that there are no limitations on the display method of the display 4. For example, the display 4 may be a projection type display, an LED display, or a liquid crystal display. In this embodiment, the play area is a flat area of width 8.0 m×depth 4.0 m, and the display has a flat display area of width 8.0 m×height 2.5 m. Note, however, that the respective sizes of the play area 8 and the display 4 may be set variously in accordance with the environment in which the game device 1 is installed.

The camera sensor 3 is installed so as to image-capture the play area 8 from the display 4 side, and an imaging angle thereof in a horizontal (left-right/panning) direction is perpendicular to a plane of the display 4. Note that the imaging angle of the camera sensor 3 in a vertical (up-down/tilt) direction is preferably adjusted as appropriate in accordance with the height position, on the display 4 side, in which the camera sensor 3 is installed and the positional relationship between the display 4 and the play area 8. In the example shown in FIG. 3, the camera sensor 3 is installed above the center of the display area, but the installation position of the camera sensor 3 is not limited to the example illustrated in this embodiment. For example, the camera sensor 3 may be installed in the center of the display area.

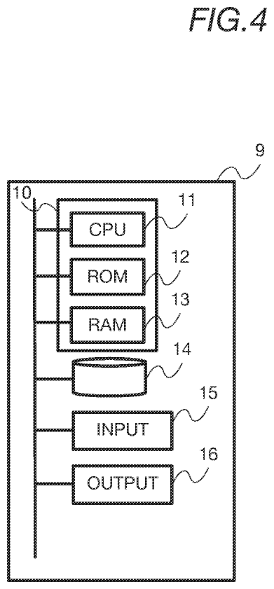

FIG. 4 is a schematic view showing a configuration of the information processing device 9 according to this embodiment. The information processing device 9 is a computer in which a CPU (Central Processing Unit) 11, a ROM (Read Only Memory) 12, a RAM (Random Access Memory) 13, an auxiliary storage device 14, an input interface 15 for receiving input from the sensor and so on, and an output interface 16 for performing output to the display 4 and so on are connected to each other either wirelessly or by wire. As regards the specific hardware configuration of the information processing device 9, constituent elements may be omitted, replaced, and added as appropriate in accordance with the embodiment.

The CPU 11 is a central processing device that controls the respective configurations provided in the information processing device 9, such as the RAM 13 and the auxiliary storage device 14, by processing commands and data expanded in the ROM 12, the RAM 13, and so on. Further, the RAM 13 is a main storage device that is controlled by the CPU 11 so that various commands and data are written thereto and read therefrom. In other words, the CPU 11, the ROM 12, and the RAM 13 together constitute a control unit 10 of the information processing device 9.

The auxiliary storage device 14 is a nonvolatile storage device to and from which mainly information to be held even after the power supply of the information processing device 9 is cut, for example an OS (Operating System) of the information processing device 9, which is loaded to the RAM 13, various programs for executing processing to be described below, and various data used by the information processing device 9, are written and read. An EEPROM (Electrically Erasable Programmable ROM), an HDD (Hard Disk Drive), or the like, for example, can be used as the auxiliary storage device 14. Further, a portable medium that can be attached to the information processing device 9 detachably may also be used as the auxiliary storage device 14. Examples of portable media include a card/cartridge type medium including a ROM or the like, a CD (Compact Disc), a DVD (Digital Versatile Disc), a BD (Blu-ray (registered trademark) Disc), and so on. An auxiliary storage device 14 constituted by a portable medium and a non-portable auxiliary storage device 14 may be used in combination.

The game device 1 according to this embodiment, similarly to the game device 1 described in the first embodiment with reference to FIG. 1, includes the object detection unit 21, the object control unit 22, the collision detection unit 23, the parameter updating unit 24, the rendering unit 25, and the display unit 26. The game device 1 according to this embodiment functions as a game device including the object detection unit 21, the object control unit 22, the collision detection unit 23, the parameter updating unit 24, the rendering unit 25, and the display unit 26 by having the CPU 11 of the information processing device 9 interpret and execute various programs expanded to the ROM 12, the RAM 13, and so on. In this embodiment, an example in which the functions of these units are all executed by the general-purpose CPU 11 will be described. However, some or all of the functions may be realized by one or a plurality of dedicated processors. Moreover, the respective function units of the game device 1 may be packaged in a cloud, a server, or the like, for example. Furthermore, the function units may be realized by a plurality of software modules rather than a single software module.

In this embodiment, a moving image processed by the respective function units to be described below is a moving image that is acquired from the camera sensor 3 installed on the display 4 side and then left-right inverted. In this embodiment, a moving image input from the camera sensor 3 is used as the raw material of an image of the virtual area used in the game, and the players play the game while viewing images of themselves displayed on the display 4, which is installed directly in front of the players. Hence, by left-right inverting the moving image, a relationship between the play area 8 in which the players are present and the displayed game screen becomes a mirror image relationship when the generated game image is displayed so as to directly face the players, which makes it easier for the players to play intuitively. Note that the timing of the processing for left-right inverting the moving image is not limited to a timing immediately after the moving image is input from the camera sensor 3. However, when the processing for detecting the real objects, the processing for disposing objects in the virtual area, and so on are performed on the basis of the moving image prior to the left-right inversion processing, the left-right inversion processing is also executed on position information relating to the detected real objects and position information relating to the objects disposed in the virtual area.

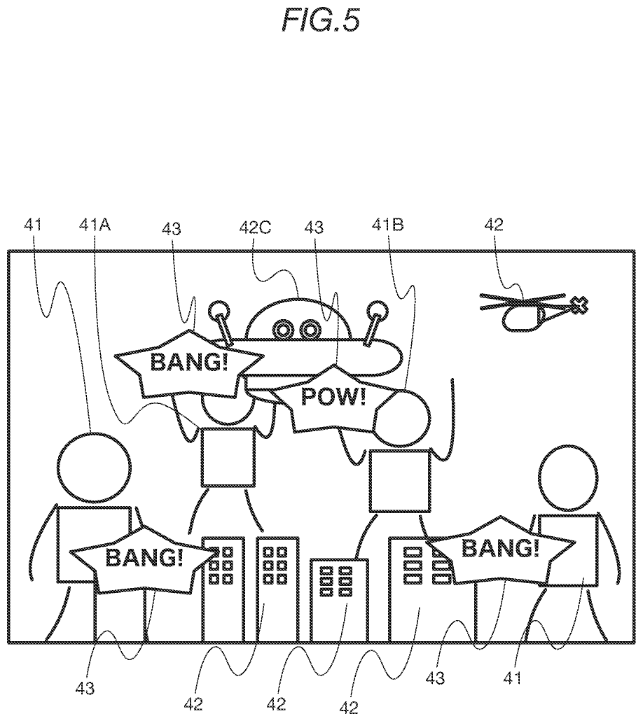

FIG. 5 is a view showing an example of a game screen rendered in this embodiment. On the game screen according to this embodiment, player objects 41 (including 41A and 41B), a game object 42 (including 42C), effect images 43, and so on are synthesized with the left-right inverted moving image. Since an image-captured moving image is used to generate the game screen, when the player is closer to the camera, the player is displayed so as to appear larger on the game screen, and thus the player can attack a wider range.

Note that although in this embodiment, a two-dimensional plane with no depth is used as the virtual area of the game, a three-dimensional space may be used as the virtual area of the game. In this case, by employing a sensor (a depth sensor or the like) capable of ascertaining three-dimensional positional relationships between the objects in the play area 8 or by estimating the three-dimensional positional relationships through image analysis, the player objects 41 and the game object 42 can be disposed in a three-dimensional virtual area. Note that when a three-dimensional virtual space is employed, three-dimensional information about the play area acquired from the sensor is subjected to y-axis inversion processing, assuming that the display area of the display is an xz plane.

The object detection unit 21 detects moving objects in the play area 8 by analyzing the moving image, which is obtained by left-right inverting the moving image acquired from the camera sensor 3, and detecting movement within the moving image. The object detection unit 21 then detects the positions of the moving objects as positions of real objects. Thus, the object detection unit 21 can detect the positions of body parts of the plurality of players and/or tools moved by the plurality of players as the positions of a plurality of real objects. In other words, in the game according to this embodiment, the players can attack the game object 42 by moving various body parts, such as their arms, hands, legs, heads, and shoulders, or tools such as sticks held in their hands, so as to make the game device 1 recognize these objects.

Note that a conventional moving image analysis technique may be used as a technique for detecting moving objects by moving image analysis, and therefore description of this technique has been omitted. Further, in this embodiment, a technique of analyzing the moving image acquired from the camera sensor 3 is cited as an example of a technique for detecting objects in the play area 8, but the technique for detecting objects in the play area 8 is not limited to the example cited in this embodiment, and objects in the play area 8 may be detected by referring to depth information acquired from a depth sensor, for example. Further, in this embodiment, only moving objects are detected, but by analyzing information acquired from various sensors, such as the camera sensor 3 and a depth sensor, body parts of a person ay be recognized and detected as real objects.

The object control unit 22 disposes the game object 42, which is the target to be attacked by the plurality of players, in the virtual area that is used for the game played by the players. In this embodiment, for example, a plurality of buildings are displayed in the lower portion of the game screen so as to fill the width of the display 4, and a flying object such as a helicopter or a UFO is displayed in the upper portion of the game screen so as to travel across the display 4. When the game object 42 is displayed in this manner, the users can attempt to attack the game object 42 by making large movements with both hands and both legs, and occasionally rolling or jumping on the floor of the play area 8.

The collision detection unit 23 detects collisions between each of the plurality of player objects 41, which are disposed in the virtual area in positions corresponding respectively to the detected positions of the plurality of real objects, and the game object 42. In this embodiment, the collision detection unit 23 detects collisions between the player objects 41 and the game object 42. Here, in the game according to this embodiment, a stationary object (an object with a movement speed not exceeding a predetermined threshold) is not detected as a real object, and in this case, the player object 41 is not disposed in the virtual space and cannot inflict damage on the game object 42. Hence, the players attack the game object 42 by actively moving around using their bodies.

The parameter updating unit 24 updates a parameter associated with the game object 42 each time the collision detection unit 23 detects a collision between one of the plurality of player objects 41 and the game object 42. Here, for example, the “parameter associated with the game object 42” is a physical strength value, an accumulated damage, or the like associated with the game object 42. In the case of a physical strength value, subtraction processing is performed each time a collision is detected, and in the case of accumulated damage, integration processing is performed each time a collision is detected. Note, however, that the updated game parameter is not limited to a parameter associated with the game object 42, and for example, an amount of damage inflicted on an enemy object, which is associated with each of the players of the game, may be updated instead.

The rendering unit 25 generates a game screen including images of the plurality of player objects 41 and an image of the game object 42 by rendering the virtual area. In this embodiment, the rendering unit 25 generates a game image by synthesizing the image of the game object 42 with the moving image obtained by left-right inverting the moving image acquired by the camera sensor 3. In other words, in this embodiment, parts of the moving image acquired by the camera sensor 3 that show the body parts or tools of the players that have been detected as the real objects are handled as is as images of the player objects 41 corresponding to the real objects.

Note that in the game device 1 according to this embodiment, the left-right inverted moving image is used as is as the images of the player objects 41, but instead, predetermined images may be displayed so as to be superimposed on the moving image in the detected positions of the objects and players. In so doing, it is possible to generate performances in which a player displayed on the moving image in the game screen appears to be wearing game equipment of some kind (a sword, a shield, armor, clothes, and so on) or producing effects of some kind (light, flames, and so on) from his/her body. Moreover, image-captured images do not have to be used on the game screen. For example, silhouettes of the users may be replaced by other displayed images (images of game characters or the like, for example).

Furthermore, in this embodiment, the rendering unit 25 renders the effect images 43, which show that collisions have occurred in the positions where the collisions are detected. In this embodiment, for example, alphabetic characters indicating effect noises such as “Bang!”, “Pow!”, and “Kaboom!” are displayed by being superimposed on the star-shaped effect images 43. The rendering unit 25 may also vary the image of the game object 42 or add an effect performance image (an image of flames, a crack, or the like) to the game object 42 in response to the infliction of damage on the game object 42. Thus, the player can recognize that the body part or tool moved thereby has struck and inflicted damage on the game object 42 in the augmented reality space.

The display unit 26 displays the game screen in a position that can be seen by the plurality of players from the play area 8. In this embodiment, as noted above, a moving image that is left-right inverted after being acquired from the camera sensor 3 installed on the display 4 side is used as the game screen, and the players play the game while viewing images of themselves displayed on the display 4 installed directly in front of the players. Hence, the relationship between the play area 8 in which the players are present and the displayed game screen is a mirror image relationship, which makes it easier for the players to play intuitively.

Processing Flow

Next, a flow of the processing executed in this embodiment will be described. Note that the specific content and processing sequences of the processing illustrated on the flowcharts according to the embodiments are merely examples of implementations of the present disclosure, and the specific processing content and processing sequence may be selected as appropriate in accordance with the embodiment of the present disclosure.

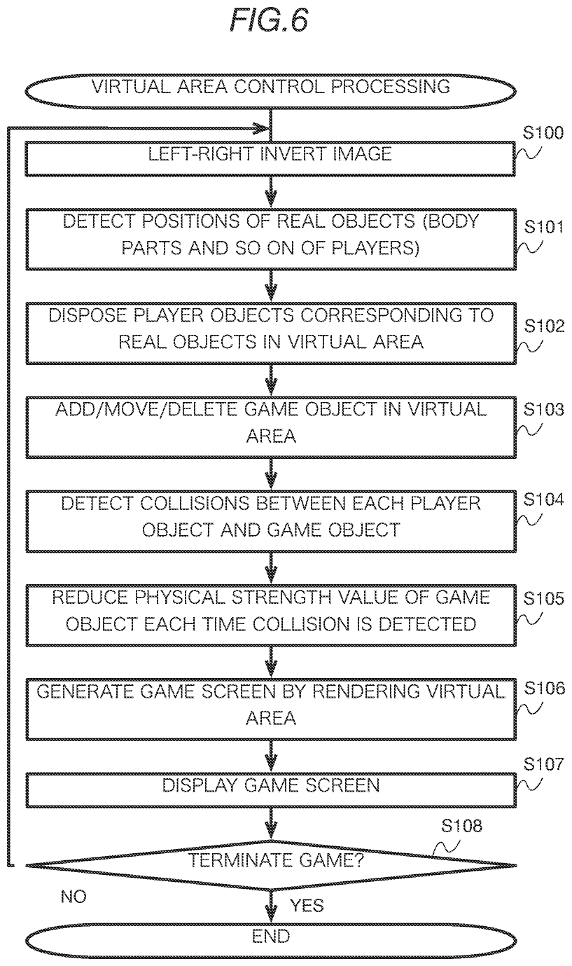

FIG. 6 is a flowchart showing a flow of virtual area control processing according to the third embodiment. The processing illustrated on this flowchart is started in the game device 1 when the processing of a game program is started, and is executed repeatedly thereafter.

In step S100, inversion processing is performed on the moving image. The information processing device 9 left-right inverts the moving image acquired from the camera sensor 3, The moving image used in the processing of the steps described below is a moving image already subjected to left-right inversion processing. The processing then advances to step S101.

In step S101, the positions of the real objects are detected. As noted above, the real objects are objects having substance and existing in a real space. The object detection unit 21 detects a plurality of moving objects within the play area 8 by analyzing the moving image subjected to left-right inversion in step S100 and detecting movement within the moving image, and detects the respective positions of the plurality of moving objects as the respective positions of a plurality of real objects. The processing then advances to step S102.

In step S102, the player objects 41 are disposed in the virtual area of the game. As noted above, the player objects 41 are objects that appear in the virtual area that is used tier the game played by the plurality of players on the game device 1 according to this embodiment, and that are manipulated by the players. The object control unit 22 disposes the plurality of player objects 41 in positions within the virtual area that correspond respectively to the detected positions of the plurality of real objects (the body parts, tools, and so on of the players, which are moved by the players) detected in step S101. In other words, in the game according to this embodiment, the players manipulate the positions of the player objects 41 in the virtual area by moving the positions of body parts, tools, and so on of the players. Note, however, that in this embodiment, the moving image acquired from the camera sensor 3 and subjected to left-right inversion is used as is as the images of the player objects 41, and therefore what are actually disposed in the virtual area are the player objects 41 used for collision detection. The processing then advances to step S103.

In step S103, the game object 42 is disposed in the virtual area of the game. As noted above, the game object 42 is a virtual object such as a character or an item that appears in the virtual area used for the game according to this embodiment, and includes an attack target of the game. The object control unit 22 disposes the game object 42 serving as the target to be attacked by the plurality of players in the virtual area that is used in the game played by the players.

In this embodiment, the object control unit 22 adds and moves the game object 42 in accordance with the progress of the game. For example, in the first half of the game, groups of buildings and helicopters that can be destroyed with a small amount of damage appear, and in the second half of the game, a UFO that can only be destroyed by inflicting a large amount of damage thereon compared to the other game objects (i.e., that is set with a larger physical strength value than the other game objects) appears as a so-called boss character. In the game device 1 according to this embodiment, the plurality of player objects 41 corresponding to the plurality of detected real objects can each inflict damage on a single game object 42, and it is therefore possible to provide a play style corresponding to a so-called raid battle, in which a plurality of players cooperate to defeat a boss character by inflicting damage on the boss character, in a game using an augmented reality technique.

Further, in this embodiment, the game object 42 moves around the virtual area on predetermined route. Note, however, that a different method may be employed for moving the game object 42. For example, the object control unit 22 may move the game object 42 randomly, may move the game object 42 toward the player objects 41 by referring to the positions and movements of the detected real objects (the player objects 41), or may move the game object 42 so as to flee from the player objects 41.

Note that the object control unit 22 deletes the game object 42 from the virtual area when the physical strength value of the game object 42 reaches 0 or less. When the game object 42 is deleted, an effect such as an explosion or disintegration may be added. The processing then advances to step S140.

In step S104, collisions between the player objects 41 and the game object 42 are detected. The collision detection unit 23 detects collisions between the plurality of player objects 41 and the game object 42 respectively disposed in the virtual area in step S102 and step S103. In other words, the game device 1 according to this embodiment detects collisions between the player Objects 41 and the game object 42 with respect to each player object 41. To describe this with reference to FIG. 5, when, for example, the player object 41A and the player object 41B collide with the same game object 42C at the same time, the game device 1 according to this embodiment detects these collisions (the collision between the player object 41A and the game object 42C and the collision between the player object 41B and the game object 42C) individually as different collisions. The processing then advances to step S105.

In step S105, the physical strength value of the game object 42 is updated in response to the detected collisions. In this embodiment, the parameter updating unit 24 reduces the physical strength value associated with the game object 42 each time the collision detection unit 23 detects a collision between one of the player objects 41 and the game object 42. The damage inflicted by the collision may be a fixed value for all collisions, or the value of the damage may increase and decrease depending on the movement speed of the player object 41 at the time of the collision or the relative speeds of the player object 41 and the game object 42 at the time of the collision. The processing then advances to step S106.

In step S106 and step S107, a game screen is generated and output. The rendering unit 25 generates a game image by synthesizing the image of the game object 42 disposed in step S103 with the moving image acquired by the camera sensor 3 and subjected to left-right inversion in step S100 (step S106).

The display unit 26 then displays the game screen on the display 4 (step S107), As noted above, the display 4 according to this embodiment has a size of width 8.0 m×height 2.5 m, which is large enough to be able to display a substantially life-sized person, and is installed in a position directly facing the players present in the play area 8 so as to be visible to the players. In addition, the moving image of the play area 8 is displayed in a left-right inverted manner so that the relationship between the play area 8 in which the players are present and the displayed game screen is a mirror image relationship. Thus, images of the bodies of the players are projected onto video of the players themselves, which is displayed on the game screen displayed on the display 4, thereby allowing the players to recognize the virtual area of the game as augmented reality, and at the same time, the players can advance the game by moving parts of their bodies, tools, or the like so as to manipulate the player objects 41 within the virtual area.

Next, the processing returns to step S101, whereupon the processing illustrated on the flowchart is executed repeatedly until a predetermined termination condition (for example, input of an instruction to terminate the game by a user or a manager, or the like) is satisfied (YES in step S108).

With the game device 1 according to this embodiment, it is possible to provide a technique that allows a many-to-one game, in which a plurality of players in a play area attack a single enemy object cooperatively, to be played without using a special controller or the like.

Other Variations

Note that in the embodiments described above, when the object detection unit detects simultaneous, identical movements by different real objects (movements in which the difference in a parameter expressing the content of the action is within the range of a predetermined threshold), a predetermined effect may be applied in the game. Bonus damage to the game object, display of a predetermined effect image or designed text effect, and so on may be cited as examples of the predetermined effect applied in this case.

What is claimed is:

1. A game device comprising:
a memory; and
a processor coupled to the memory, the processor being configured to execute a program comprising:
detecting positions of a plurality of real objects from a predetermined area, in which a plurality of players are present, on the basis of information input from a sensor for sensing the predetermined area;
disposing a game object in a virtual area used for a game played by the plurality of players;
detecting, in the virtual area, collisions between each of a plurality of player objects, which are disposed in positions corresponding to the detected positions of the plurality of real objects, and the game object;
updating a parameter of the game each time the collision detection detects a collision between each of the plurality of player objects and the game object;
rendering the virtual area and generating a game screen that includes images of the plurality of player objects and an image of the game object; and
displaying the game screen at a position visible to the plurality of players in the predetermined area.

2. The game device according to claim 1, wherein detecting positions of the plurality of real objects includes detecting positions of moving objects as the positions of the real objects, and
wherein detecting the collisions between each of the plurality of player objects includes detecting collisions between player Objects corresponding to the moving objects and the game object.

3. The game device according to claim 2, wherein the sensor is an imaging device configured to acquire a moving image by image-capturing the predetermined area, and
wherein detecting positions of the plurality of real objects includes detecting the moving objects by analyzing the moving image and detecting movement within the moving image.

4. The game device according to claim 3, wherein rendering includes using at least a part of the moving image as the images of the plurality of player objects.

5. The game device according to claim 1, wherein detecting positions of the plurality of real objects includes detecting positions of body parts of the plurality of players and/or tools moved by the plurality of players as the positions of the plurality of real objects.

6. The game device according to claim 1, wherein the processor is configured to update a parameter associated with the game object.

7. A game processing method executed by a computer, comprising:
detecting positions of a plurality of real objects from the predetermined area on the basis of information input from a sensor, the sensor connected to the computer and configured to sense a predetermined area where a plurality of players are present;
disposing a game object in a virtual area used for a game played by the plurality of players;
detecting, in the virtual area, collisions between each of a plurality of player objects, which are disposed in positions corresponding to the detected positions of the plurality of real objects, and the game object;
updating a parameter associated with the game object each time a collision between each of the plurality of player objects and the game object is detected in the collision detection;
generating a game screen that includes images of the plurality of player objects and an image of the game object by rendering the virtual area; and
displaying the game screen on a display device at a position visible to the plurality of players in the predetermined area.

8. A non-transitory computer-readable recording medium having recorded thereon a game processing program for causing a computer to:
detect positions of a plurality of real objects from the predetermined area on the basis of information input from a sensor, the sensor connected to the computer and configured to sense a predetermined area where a plurality of players are present;
dispose a game object in a virtual area used for a game played by the plurality of players;
detect, in the virtual area, collisions between each of a plurality of player objects, which are disposed in positions corresponding to the detected positions of the plurality of real objects, and the game object;
update a parameter associated with the game object each time a collision between each of the plurality of player objects and the game object is detected in the collision detection;
generate a game screen that includes images of the plurality of player objects and an image of the game object by rendering the virtual area; and
display the game screen on a display device at a position visible to the plurality of players in the predetermined area.
